(19) United States
(12) Patent Application Publication
(10) Pub. No.: US 2011/0247250 A1
(43) Pub. Date: Oct. 13, 2011

(54) SIGN COVER AND METHOD OF USE

(76) Inventor: JOE DUDAK, VICTORIA, MN (US)

(21) Appl. No.: 12/757,637

(22) Filed: Apr. 9, 2010

(51) Int. Cl. G09F 7/00; D05B 23/00

(52) U.S. Cl. 40/603; 40/584; 112/475.08

(57) ABSTRACT

A cover for an advertising board includes a first face made of fabric and a second face made of fabric. The first and second faces are coupled together to form a cover conforming to the advertising board.

### TECHNICAL FIELD

The present description relates, generally, to advertising and, more specifically, to sign covers.

### BACKGROUND

Retail establishments, such as malls and department stores, currently use conventional upright advertising boards to display various advertisements. A conventional upright advertising board typically includes a cardboard or foam board that has dimensions of about thirty-eight inches by seventy-two inches by one-half inch thick. The board is installed so that it is vertical and held by a support base on the floor. The support base extends horizontally for a few inches along the floor to provide stability to the upright advertising board and also has upright components that form a gap narrow enough to hold snugly the bottom few inches of the advertising board. Furthermore, the upright advertising board usually has an advertisement printed on one or both faces. A conventional upright advertising assembly 100 is shown in FIG. 1. The assembly 100 includes a board 101, a base 102, and an advertisement 103 printed upon the board. It is noted that the advertisement could cover the entire board.

Typical use of an upright advertising board is as follows: An advertiser orders a board with a particular advertisement thereon from a manufacturer/printer. The advertiser then installs the advertising board on a reusable base in a public place. After some amount of time, the advertiser may desire to change the advertisement. Accordingly, the advertiser orders another board with another advertisement thereon. The advertiser uses the new board to replace the old board and usually discards the old board either in trash or recycling. Replacing the boards and discarding them is not environmentally beneficial. In addition, shipping new boards can be relatively expensive due to their fragile nature. Therefore, improvements are desirable.

### BRIEF SUMMARY

Various embodiments include covers for advertising boards and methods for use thereof. In one example, a cover for an advertising board includes a first face made of fabric and a second face made of fabric. The first and second faces are coupled together to form a cover conforming to the advertising board. In another example, a method includes displaying a first advertisement on an advertising board and installing a fabric cover over the advertising board. The fabric cover displays a second advertisement. The second advertisement may replace or supplement the first advertisement. In yet another example, an apparatus includes a means for elastically and opaquely covering an advertising board substantially completely and without perceptible wrinkles. In yet another example, a method for creating an advertising sign cover from fabric includes cutting the fabric to create a first face and a second face. The faces are stitched together so that the first and second faces form the advertising sign cover and conform to the shape of an advertising sign to provide a slightly stretched fit over the advertising sign. An advertisement is applied to the first face after cutting.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 shows a conventional upright advertising assembly;

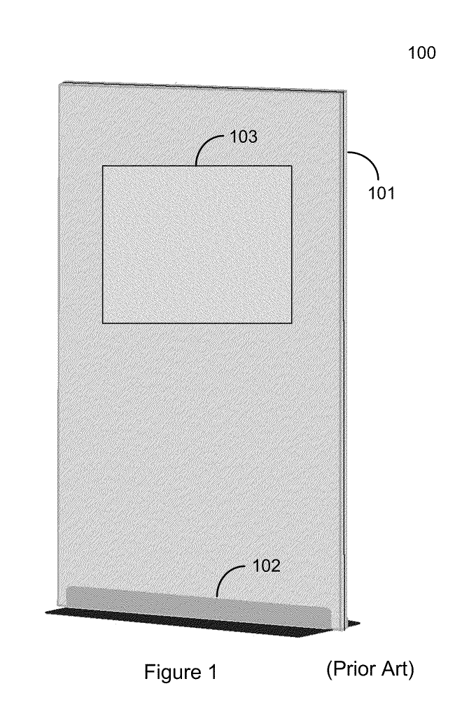

FIG. 2 is an illustration of an exemplary sign cover installed over an upright advertising board, according to one embodiment;

FIG. 3 shows the sign cover of FIG. 2; and

FIG. 4 is an illustration of an exemplary method adapted according to one embodiment.

### DETAILED DESCRIPTION

The inventor of the present application has noticed that the conventional technique of periodic replacement of upright advertising boards creates waste and is unnecessarily expensive. Various embodiments described herein can be used to provide for reuse of upright advertising boards.

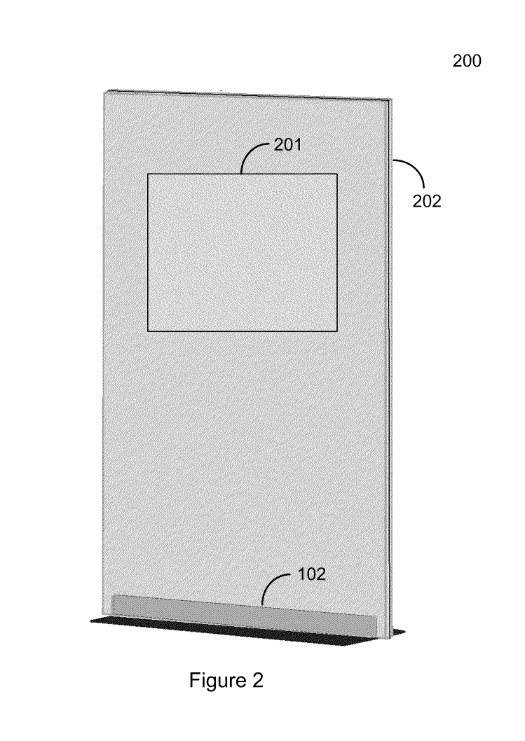

FIG. 2 is an illustration of an exemplary sign cover 200 installed over an upright advertising board, according to one embodiment. The upright advertising board is not shown in FIG. 2, as it is substantially completely obscured by the sign cover 200. The sign cover 200 includes an advertisement 201 on one face, which could cover the entire cover 200, and it is understood that the face not shown in FIG. 2 may also, in some embodiments, have the same or different advertisement thereon as well. The base 102 is used to stabilize the assembly, and, as shown in FIG. 2, preferably the sign cover 200 is stretched low enough to cover at least part of the base 102.

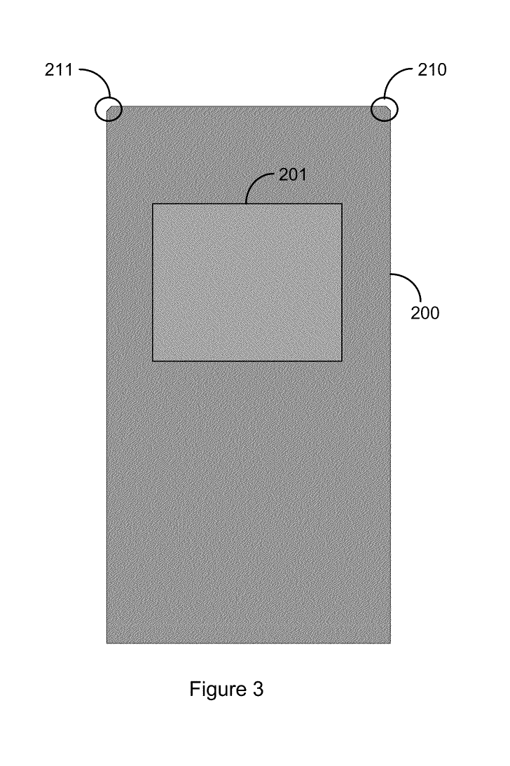

The example sign cover 200 is made of two cut pieces of a slightly stretchy fabric, such as polyester. Other embodiments may include other fabrics. The two pieces of fabric are precision cut using, e.g., rotary heat slitting, heat chopping, and/or the like. The two pieces are then sewn back-to-back and inside-out using precision stitching, though other coupling techniques are possible. Seam 202 is shown in FIG. 2. FIG. 3 shows the sign cover 200 by itself. Of note in FIG. 3 is that the corners 210 and 211 are preferably cut at forty-five degrees to facilitate a final fit on the upright advertising board. A forty-five degree cut is exemplary, as other angled cuts may be used in other embodiments.

In many applications, the fabric is chosen so that it has a non-reflected, or non-glare surface. Furthermore, some applications include more than two pieces of material. For example, in one embodiment, one or more opaque layers (e.g., black) are placed between the outside surfaces of the cover and the surface of the board in order to prevent the board from being seen through the fabric cover. The opaque layers may be made of the same material, or a different material, than are the fabric pieces that are on the exterior. In fact, any appropriate number of layers may be used in a given embodiment. The fabric layers are stitched together using a performance stitching. The fabric layers are stitched together using a performance straight stitch with reverse stitching to bond together all ends and corners. Straight stitch is used to give a clean smooth look on all edges. Preferably, the thread is polyester mono-filiment.

The sign cover 200 is made to be about the same dimensions as the board over which it is intended to be installed. The sign cover 200 is made so that it fits tightly over the board, taking advantage of the flexibility of the fabric. After installation, the fabric of the cover is stretched somewhat, but there is some elasticity left so that a human may pinch the fabric and perceive at least some stretchiness. The goal of the installation is to have a tight fit with no wrinkles or bagginess to give the appearance of the original board, assuming the cover is installed correctly.

During installation, edge caps may be placed on the board. Preferably, the edge caps are already on the board from the original board. When installing over the edge caps, the edge caps keep the material taunt and create a slight gap between the cover and the board. This helps cover any damage that may have incurred to the original board. The sign cover 200 is then placed over the board so that it fits tightly, as explained above. The sign cover 200 can be straightened so that it is perceptibly free of wrinkles, at least by casual observation of a shopper. In other words, a shopper would preferably perceive no wrinkles in the sign cover 200 when observing the sign cover 200 in a manner in which a shopper ordinarily would be expected to view the sign cover 200.

Either before or after the sign cover 200 is sewn together, the advertisement 201 may be applied. Various processes may be used, including dye sublimation printing or any other processes now known or later developed. Adhesive paper may be placed on the fabric during printing so that the fabric does not shrink.

While the cover 200 is shown as covering the entirety of the upright advertising board, it should be noted that the scope of embodiments is not so limited. For instance, in other embodiments, a cover may obscure only part of an advertising board so as to hide only a particular portion and/or to supplement an advertisement currently on the upright advertising board. It is noted that the cover can be removed after a period of time and replaced with another cover or to show the original board again. Thus, the covers can be continuously replaced with new covers over time as new advertisements are desired. The cover could also simply cover the original board for a period of time to mask its advertisement. In this embodiment, the cover may or may not have an advertisement printed on it. The cover could also be used to preserve the original board from damage, fading, etc. . . .

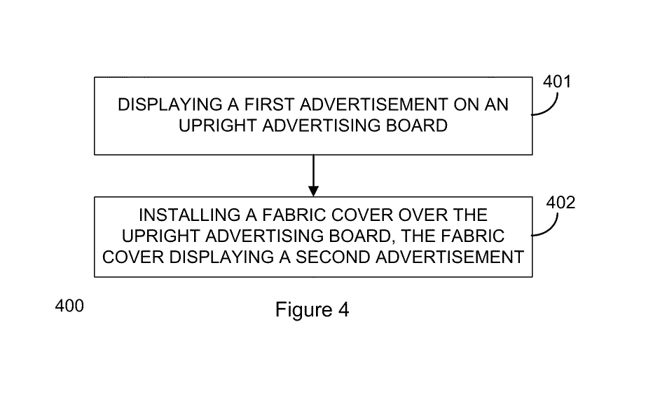

FIG. 4 is an illustration of an exemplary method 400 adapted according to one embodiment. The method 400 may be performed, for example, by an advertiser who uses boards as well as fabric covers or any other entity that installs or manages advertising boards.

In block 401, a first advertisement is displayed on an upright advertising board. In block 402, a fabric cover is installed over the upright advertising board. The fabric cover has a second advertisement thereon. The fabric cover can replace the first advertisement with the second advertisement or use the second advertisement to supplement the first advertisement.

In some embodiments, the block 402 includes placing at least one edge cap on the upright advertising board and covering the upright advertising board and the at least one edge cap with the fabric cover. Furthermore, the block 402 may also include placing the fabric cover on the upright advertising board so that the fabric cover is slightly stretched and perceptibly wrinkle-free. The block 402 may also include placing the fabric cover such that it partially or fully covers the base.

Various embodiments are not limited to the actions shown in the method 400. Instead, various embodiments may add, omit, modify, or rearrange some actions. For instance, in some embodiments, the fabric cover may be replaced by another fabric cover or covered over by another fabric cover with a third advertisement thereon. In fact, fabric covers can be used to extend the life of a given upright advertising board by allowing the advertisement on the upright advertisement board to be supplemented or replaced many times without replacing the upright advertising board itself.

Furthermore, while examples above show covering a conventional upright advertising sign, various embodiments are not so limited. For instance, other signs now known or later developed, such as signs that hang from ceilings or are attached to walls, may be covered with fabric covers, such as the fabric covers described above using the techniques described above.

Various embodiments may include one or more advantages over conventional upright advertising boards. For instance, fabric covers can sometimes be manufactured more cheaply than can upright advertising boards and may, therefore, reduce costs for some advertisers. Furthermore, fabric covers may reduce waste by allowing reuse of upright advertising boards for second and subsequent advertisements.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A cover for an advertising board, the cover comprising:
a first face made of fabric; and
a second face made of fabric, the first and second faces coupled together to form a cover conforming to a shape of the advertising board.

2. The cover of claim 1 wherein the first and second faces include precision stitching.

3. The cover of claim 1 wherein at least two corners of the cover are cut at an angle between zero and ninety degrees.

4. The cover of claim 1 wherein the fabric comprises at least one of the following items:
polyester; poplin; or tri-poplin.

5. The cover of claim 1 wherein at least one of the faces includes an advertisement.

6. The cover of claim 1 further comprising an opaque liner.

7. The cover of claim 1 wherein the cover has no perceptible wrinkles when fit over the advertising board.

8. A method comprising:
displaying a first advertisement on an advertising board;
installing a fabric cover over the advertising board, the fabric cover displaying a second advertisement.

9. The method of claim 8 wherein the fabric cover substantially completely covers the advertising board.

10. The method of claim 8 wherein the fabric cover fits over the advertising board in a manner that stretches the fabric.

11. The method of claim 8 wherein the fabric cover fits over the board with no perceptible wrinkles.

12. The method of claim 8 wherein the fabric cover covers at least a portion of a support base of the advertising board.

13. The method of claim 8 wherein installing the fabric cover comprises:
placing at least one edge cap on the advertising board; and
covering the advertising board and the at least one edge cap with the fabric cover.

14. The method of claim 8 wherein the second advertisement replaces the first advertisement.

15. The method of claim 8 wherein the second advertisement supplements the first advertisement.

16. An apparatus comprising:
a means for elastically and opaquely covering an advertising board substantially completely and without perceptible wrinkles.

17. The apparatus of claim 16 wherein the covering means includes an advertisement.

18. A method for creating an advertising sign cover from fabric comprising:
cutting the fabric to create a first face and a second face;
stitching the faces together so that the first and second faces form the advertising sign cover and conform to the shape of an advertising sign to provide a slightly stretched fit over the advertising sign; and
applying an advertisement to the first face after said cutting.

19. The method of claim 18 further comprising:
cutting at least one corner of the advertising sign cover at an angle between zero and ninety degrees.

20. The method of claim 18 in which the first and second faces are stitched back-to-back and inside-out.

21. The method of claim 18 wherein the first and second faces are precision cut using at least one of: rotary heat slitting and precision heat chopping.
